(19) United States
(12) Patent Application Publication
(10) Pub. No.: US 2019/0074976 A1
(43) Pub. Date: Mar. 7, 2019

(54) Collaborative Signature System and Method

(71) Applicant: NetProtec LLC, Glen Rose, TX (US)

(72) Inventor: Kerry Hancock, Glen Rose, TX (US)

(21) Appl. No.: 16/115,101

(22) Filed: Aug. 28, 2018

Related U.S. Application Data
(60) Provisional application No. 62/553,395, filed on Sep. 1, 2017.

(51) Int. Cl. H04L 9/32; G06F 21/64; H04L 29/06; G06F 3/14

(52) U.S. Cl. CPC H04L 9/3247; G06F 21/64; G06F 3/04842; H04L 67/38; G06F 3/1454; H04L 63/12

(57) ABSTRACT

A collaborative signature system is disclosed. The system includes document templates stored in a database and representing documents that are to be signed. The system also includes a remote server executing program code to deliver the document templates to signees for approximately simultaneous viewing and data entry including checkbox checks, text input, dates, lists, or numbers, as well as entry of digital signatures by each signee. The remote server processes the signature of each signee and displays it to the other signees at the same time.

### CROSS REFERENCE TO RELATED APPLICATIONS

This application claims the priority benefit of U.S. Provisional Patent Application No. 62/553,395 filed Sep. 1, 2017 for “Collaborative Signature System and Method,” hereby incorporated by reference in its entirety as though fully set forth herein.

### BACKGROUND

Signatures can be used informally to acknowledge someone's authorship of a writing they have made, such as a letter. However, they are also used to signify mutual consent to a writing such as a contract, terms and conditions, license agreement, etc. Due to advances in technology, electronic signatures are now accepted and legally binding in most cases. Electronic signatures also enable parties that are physically remote from one another to sign a document without having to physically transport multiple hard copies and sign in front of witnesses, or else make travel arrangements to be in the same room when the document is signed.

### BRIEF DESCRIPTION OF THE DRAWINGS

FIG. 1 is a high-level network diagram illustrating a networked environment which may implement the example collaborative signature system and method.

FIG. 2 is a process diagram illustrating implementation of a template in the example collaborative signature system and method.

FIG. 3 is a flow chart illustrating the example collaborative signature system and method.

FIG. 4 is a screenshot illustrating an example use-case of the collaborative signature system and method.

FIG. 5 is a screenshot illustrating an example use-case of the collaborative signature system and method.

FIG. 6 is a screenshot illustrating an example use-case of the collaborative signature system and method.

FIG. 7 is a screenshot illustrating an example use-case of the collaborative signature system and method.

FIG. 8 is a screenshot illustrating an example use-case of the collaborative signature system and method.

FIG. 9 is a screenshot illustrating an example use-case of the collaborative signature system and method.

FIG. 10 is a screenshot illustrating an example use-case of the collaborative signature system and method.

FIG. 11 is a screenshot illustrating an example use-case of the collaborative signature system and method.

FIG. 12 shows an example template.

### DETAILED DESCRIPTION

A collaborative signature system and method is disclosed. An example collaborative signature system includes at least one template stored in a database, the at least one template representing a document that is to be signed. The example collaborative signature system also includes a remote server executing program code to deliver the at least one template to at least a first signee and a second signee so that both signees can see the document to be signed substantially simultaneously. The remote server processes and displays for both signees the signature of the first signee substantially simultaneously. The remote server also processes and displays for both signees the signature of the second signee substantially simultaneously.

Before continuing, it is noted that as used herein, the terms “includes” and “including” mean, but is not limited to, “includes” or “including” and “includes at least” or “including at least” The term “based on” means “based on” and “based at least in part on.”

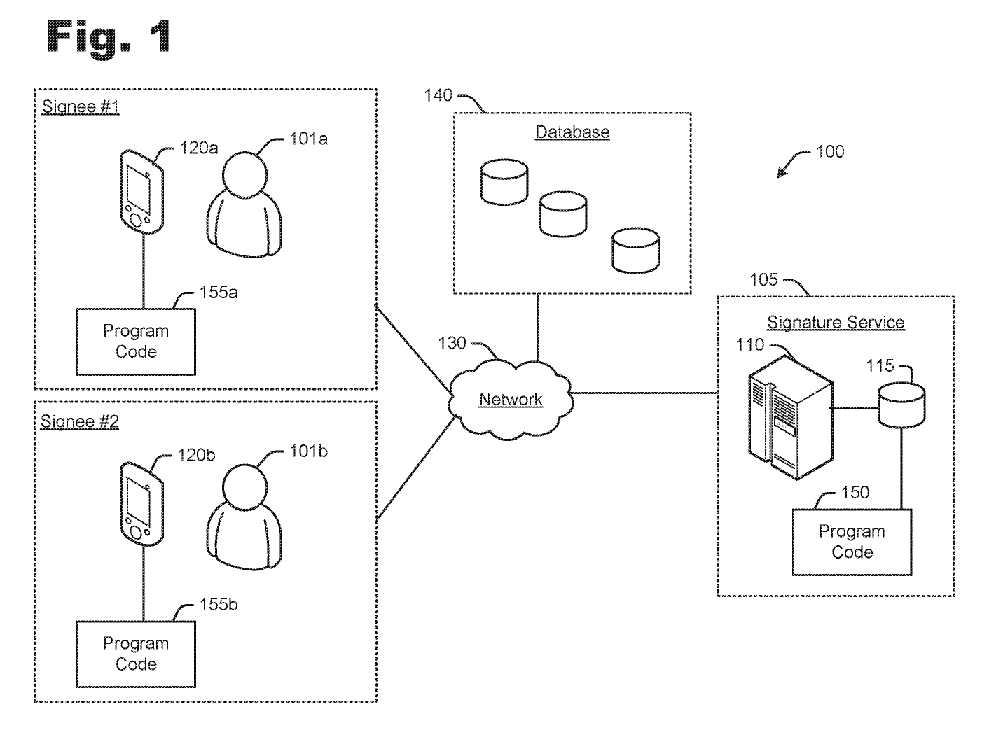

FIG. 1 is a high-level network diagram illustrating a networked environment which may implement the example collaborative signature system and method. The system 100 may be implemented with any of a wide variety of computing devices, such as, but not limited to, stand-alone desktop/laptop/netbook computers, workstations, server computers, blade servers, mobile devices, and appliances (e.g., devices dedicated to providing a service), to name only a few examples. Each of the computing devices may include memory, storage, and a degree of data processing capability at least sufficient to manage a communications connection either directly with one another or indirectly (e.g., via a network). In an example, at least one of the computing devices is also configured with sufficient processing capability to execute the program code described herein.

In an example, the system 100 may include a host 110 providing a signature service 105 accessed by a user (e.g., Signee#1 101a and Signee#2 101b) via a client device 120a and 120b, respectively. For purposes of illustration, the signature service 105 may be an online data processing service executing on a host 110 configured as a server computer with computer-readable storage 115. The client 120a and 120b may be any suitable computer or computing device (e.g., mobile phone, tablet, desktop computer, etc.) capable of accessing the host 110. Host 110 and client 120a-b are not limited to any particular type of devices.

Although, it is noted that the operations described herein may be executed by program code 155a-b residing on the clients 120a-b (e.g., a personal computer), but in some instances (e.g., where the client is a tablet or mobile device) may be better performed on a separate computer system having more processing capability, such as a server computer or plurality of server computers on a local area network for the client device.

The system 100 may also include a communication network 130, such as a local area network (LAN) and/or wide area network (WAN). In one example, the network 130 includes the Internet or other mobile communications network (e.g., a WIFI or 4G mobile device network). The network 130 may also provide greater accessibility to the signature service 105 in distributed environments, for example, where more than one user may have input and/or receive output from the signature service 105.

The host 110 and clients 120a-b may be provided on the network 130 via a communication connection, such as via an Internet service provider (ISP). In this regard, the clients 120a-b are able to access host 110 directly via the network 130, or via an agent, such as another network.

In an example, the program code 150 has access to both the clients 120a and 120b and the signature service 105 in the networked computer system 100. For example, the signature service 105 may be a cloud-based service, wherein the program code is executed on at least one computing device local to the clients 120a-b, but having access to the signature service 105 in the cloud computing system.

Before continuing, it is noted that the computing devices are not limited in function. The computing devices may also provide other services in the system 100. For example, host 110 may also provide transaction processing services and email services for the clients 120a-b.

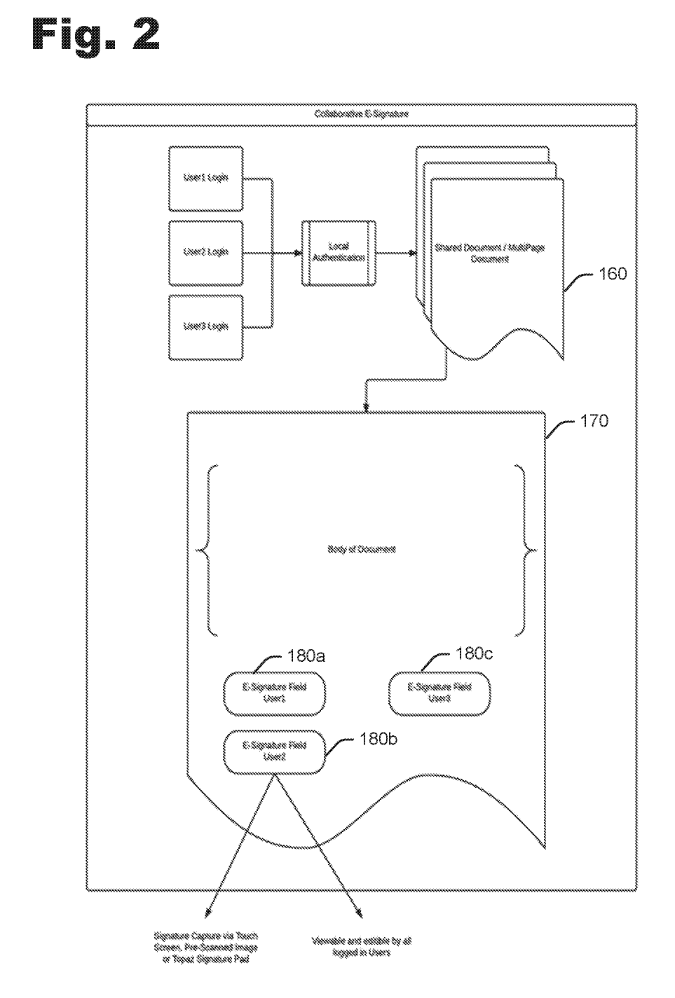

In addition, the signature service 105 may include at least one remote source 140 of content (e.g., templates in FIG. 2), and/or the signature service 105 may be operable to communicate with at least one remote source 140 of content. That is, the source may be part of the signature service 105, and/or the source may be physically distributed in the network and operatively associated with the signature service 105. In any implementation, the source may include any content. For example, the source 140 may include databases for providing information, applications for providing application data, storage resources for providing online storage facilities. There is no limit to the type or amount of content (e.g., templates) that may be provided by the source. In addition, the content may include unprocessed or “raw” templates, or the content may undergo at least some level of processing.

In an example, the collaborative signature system includes at least one template (see, e.g., FIG. 2) stored in a database 140, the at least one template representing a document that is to be signed. The example collaborative signature system also includes a remote server 110 executing program code 150 to deliver the at least one template to at least a first signee 101a and a second signee 101b so that both signees can see the document to be signed substantially simultaneously. The remote server 110 processes and displays for both signees 101a and 101b the signature of the first signee substantially simultaneously. The remote server 110 also processes and displays for both signees 101a-b the signature of the second signee substantially simultaneously.

The remote server may also process and display for both signees substantially simultaneously other entries to the document to be signed. For example, the other entries include at least one checkbox selectable by at least one of the signees. The other entries may also include at least one text input by at least one of the signees.

In an example, the signatures of the signees 101a-b is captured by touch screen, pre-scanned image, mouse or signature pad.

In an example, the document to be signed, and signatures of the signees are viewable by all logged-in users regardless of status as a signee. In another example, it may be necessary or desirable for documents or signatures to be editable by logged-in users who are not signees, and so the system 100 is capable of granting such permissions either globally or on a per-user basis.

Program code used to implement features of the system can be better understood with reference to FIG. 2 and the following discussion of various example functions. However, the operations described herein are not limited to any specific implementation with any particular type of program code.

FIG. 2 is a process diagram illustrating implementation of a template 160 in the example collaborative signature system and method. In an example, the program code discussed above with reference to FIG. 1 may be implemented in machine-readable instructions (such as but not limited to, software or firmware) to process a document template 160. The machine-readable instructions may be stored on a non-transient computer readable medium and are executable by one or more processor to perform the operations described herein. It is noted, however, that the template 160 shown in FIG. 2 is provided only for purposes of illustration of an example operating environment, and is not intended to limit implementation to any particular system.

The program code executes the function of the architecture of machine readable instructions as self-contained modules. These modules can be integrated within a self-standing tool, or may be implemented as agents that run on top of an existing program code.

The program code may execute the example collaborative signature method by retrieving at least one template 160 stored in a database, the at least one template 160 representing a document 170 that is to be signed. The program code may further deliver the at least one template to at least a first signee and a second signee so that both signees can see the document to be signed 170 substantially simultaneously. The program code may further process and display for both signees the signature of the first signee 180a substantially simultaneously, and process and display for both signees the signature of the second signee 180b (and, if applicable, the signature of a third signee 180c, fourth signee 180d, etc.) substantially simultaneously.

In an example, the program code may execute the example collaborative signature method by processing and displaying for both signees substantially simultaneously other entries to the document to be signed. The other entries include at least one checkbox selectable by at least one of the signees. The other entries include at least one text input by at least one of the signees.

In an example, the program code may execute the example collaborative signature method by capturing the signatures of the signees by touch screen, pre-scanned image, mouse or signature pad.

In an example, the signees are physically remote from one another. In an example, the signees are authenticated by video, biometric data, ID card, or other method known in the art. In an example, the document to be signed, and signatures of the signees are viewable and/or editable by all logged in users regardless of their status as a signee.

Before continuing, it should be noted that the examples described above are provided for purposes of illustration, and are not intended to be limiting. Other devices and/or device configurations may be utilized to carry out the operations described herein.

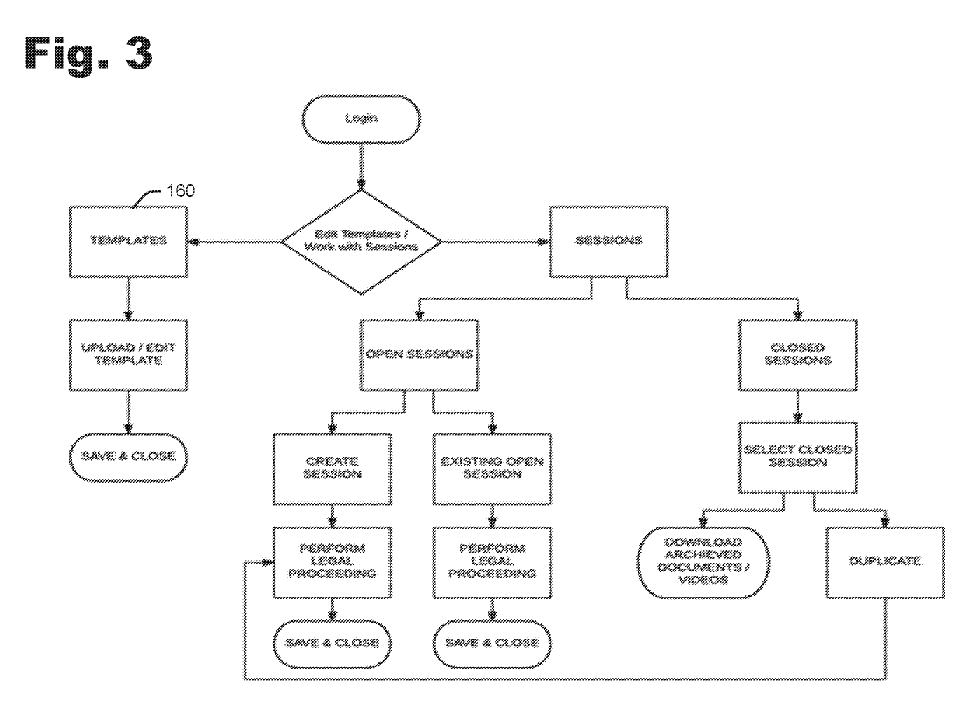

FIG. 3 is a flow chart illustrating the example collaborative signature system and method. In an example, the components and connections depicted in the figure may be employed in the collaborative signature system and method. The operations shown and described herein are provided to illustrate example implementations. It is noted that the operations are not limited to the ordering shown. Still other operations may also be implemented.

The operations may be implemented at least in part using an end-user interface (e.g., web-based interface). In an example, the end-user is able to make predetermined selections, and the operations described above are implemented on a back-end device to present results to a user. The user can then make further selections. It is also noted that various of the operations described herein may be automated or partially automated.

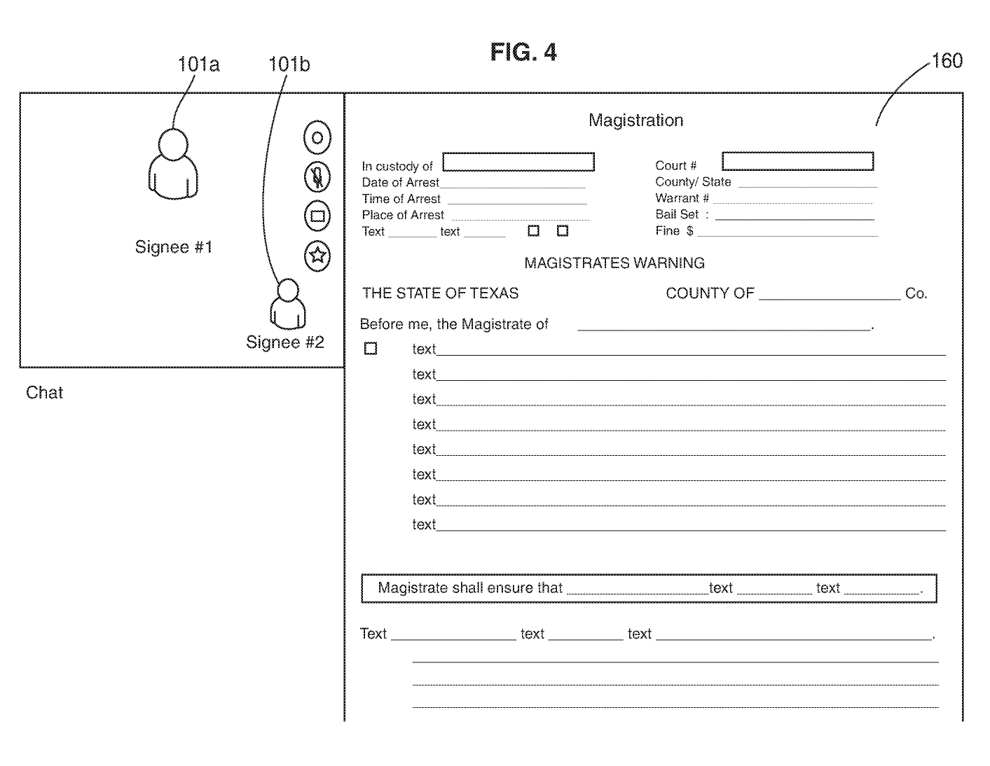

FIG. 4 is a screenshot illustrating an example use-case of the collaborative signature system and method. In this example, the document to be signed is a Magistrate Warning. The document is to be signed by a first signee 101a (e.g., the Magistrate or Magistrate's representative). The document is also to be signed by a second signee 101b (e.g., the Accused of a crime). The document may also to be signed by a third-party (e.g., a witness such as a Jailor).

It is noted, however, that any document may be signed, and the collaborative signature system and method is not limited to the criminal justice system and may be implemented with any of a wide variety of documents and use-scenarios, including but not limited to, closing documents on a real estate or other business transaction, contracts, terms of use or other agreements, etc.

In an example, a session is started when a user logs in. Sessions are instances of video (both live feed and recorded for session history) and document sharing based around a single interchange between two or more individuals. Sessions allow for video recording and document sharing of preloaded templates in a collaborative environment. This is achieved with real-time editing using a publisher/subscriber architecture. This means the client(s) looking at a document are subscribed to any subsequent changes to the document such that they are notified every time a user changes a field (these fields include all of the available field types listed for the templates). When all the changes are complete, in this example, the system uses a custom PDF renderer to merge the changes with the original PDF template, with the final product being an uneditable 128-bit encrypted PDF document, or similar document storage, display, and encryption format. It is noted that any suitable format, encryption, etc. may be employed depending on design preferences.

Open sessions are currently active sessions that can be actively joined by all invited attendees. In the illustration of an open session shown in FIG. 4, a live video feed is shown on the left of both Signee #1 and Signee #2. Typical video conferencing buttons may also be provided, and the video may be stored for future reference or authentication purposes. The document to be signed is based on a template and displayed on the right side of the users screens.

In the example shown in the Figure, no information has been entered into the template 160.

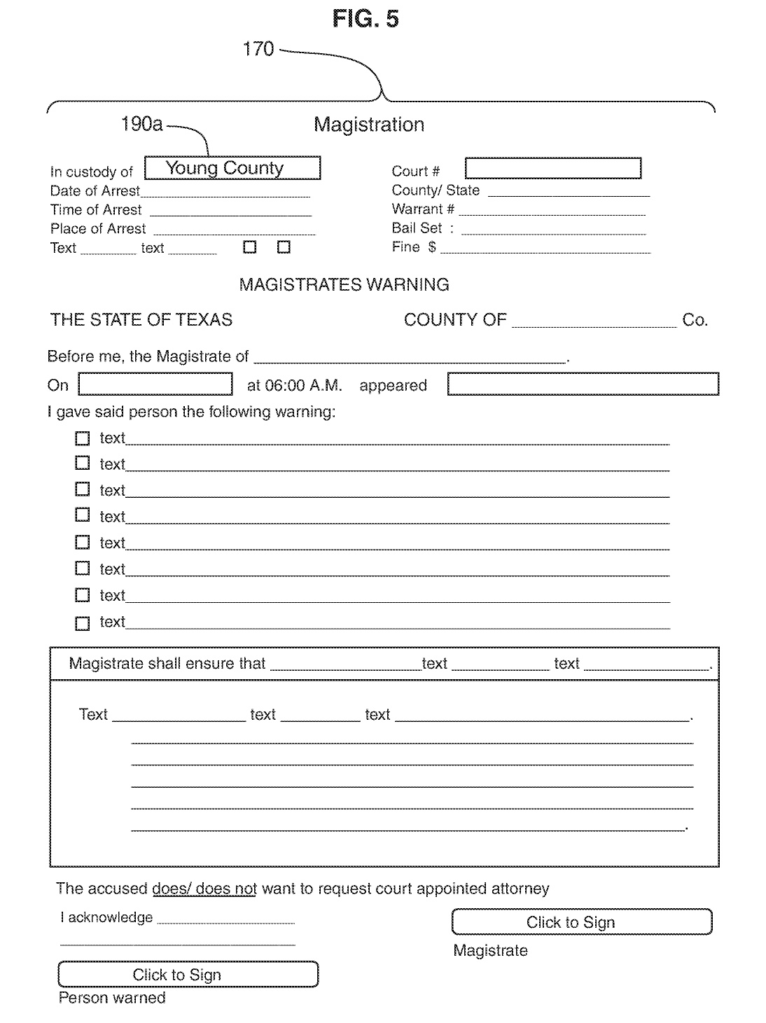

FIG. 5 is a screenshot illustrating an example use-case of the collaborative signature system and method. In this example, a first text field 190a has been filled out, and the template 160 has now become a signable document 170.

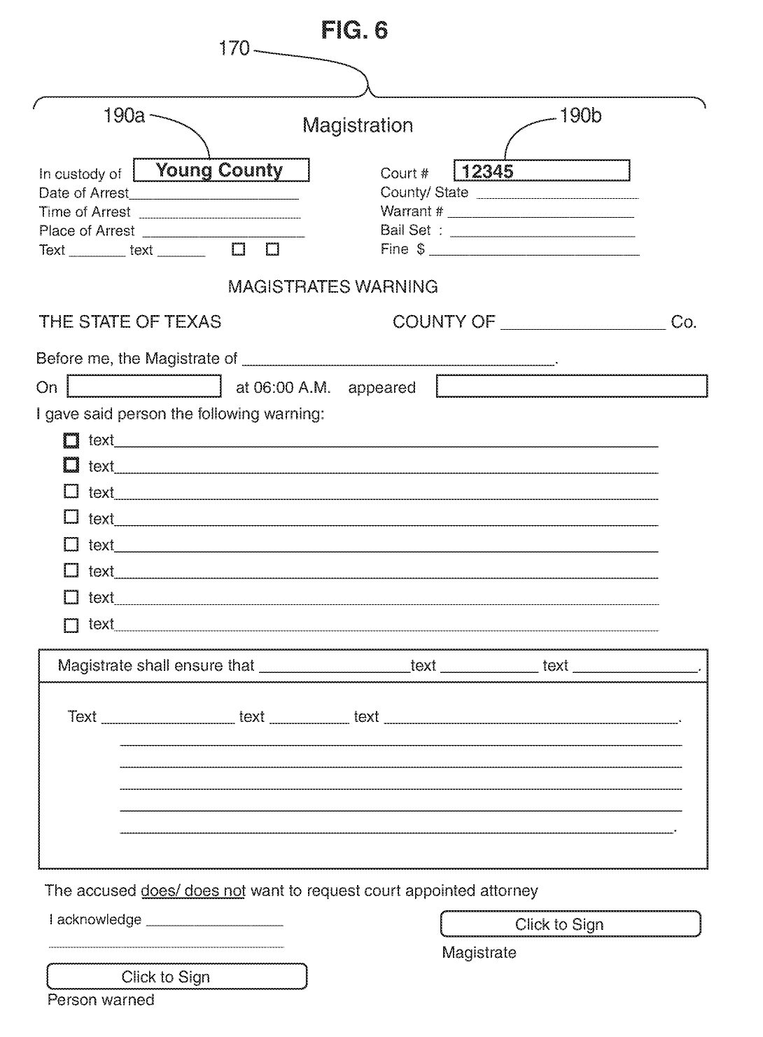

FIG. 6 is a screenshot illustrating an example use-case of the collaborative signature system and method. In this example, the first text field 190a remains filled out, and a second text field 190b within the document 170 has been filled out.

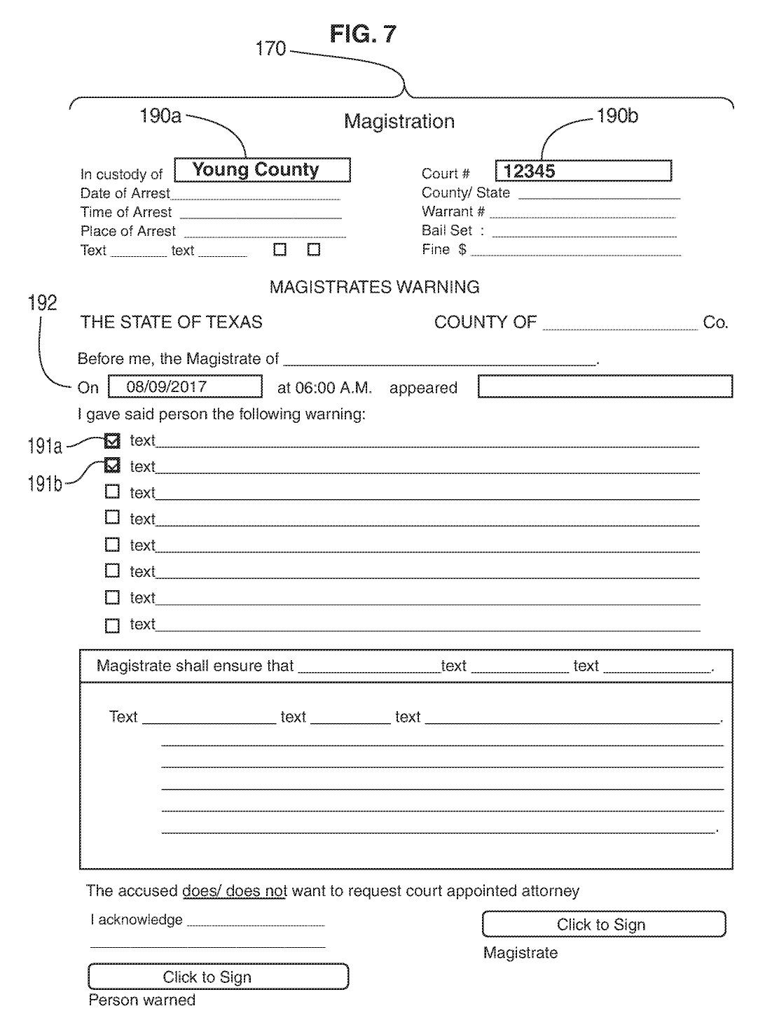

FIG. 7 is a screenshot illustrating an example use-case of the collaborative signature system and method. In this example, the two text fields 190a and 190b within the document 170 remain filled, and a date field 192 within the document 170 has been filled out, and in addition two check boxes 191a and 191b have been checked. In this example, the document 170 is now ready for signing.

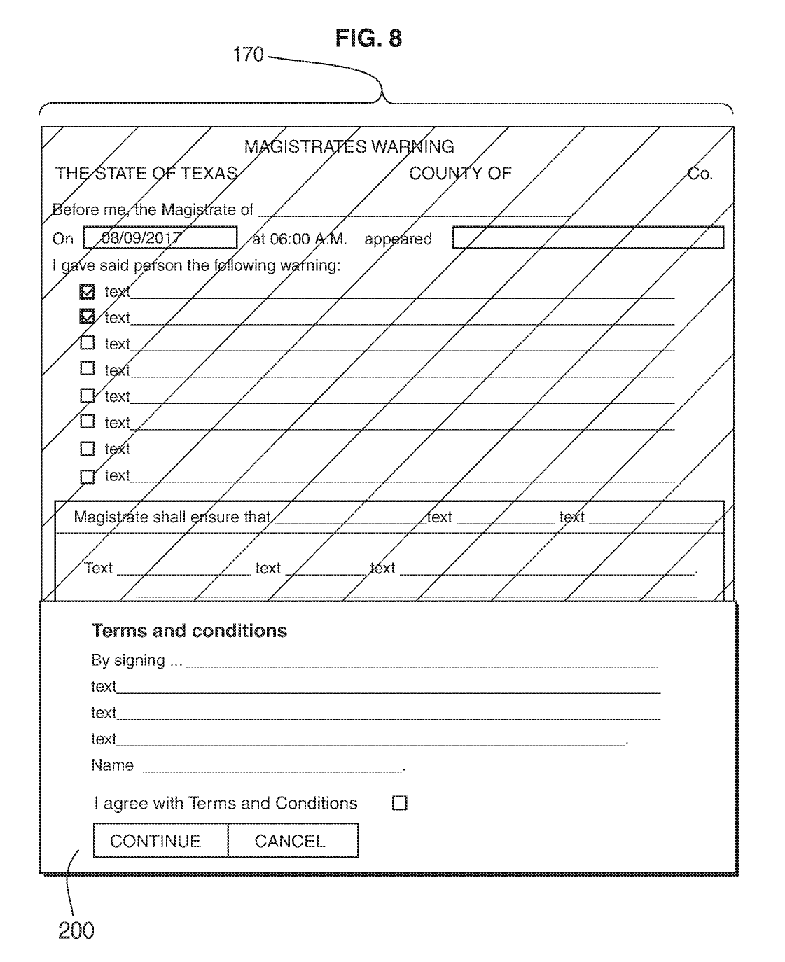

FIG. 8 is a screenshot illustrating an example use-case of the collaborative signature system and method. In this example, the document 170 is temporarily grayed out and uneditable, while a signature box 200 has been displayed.

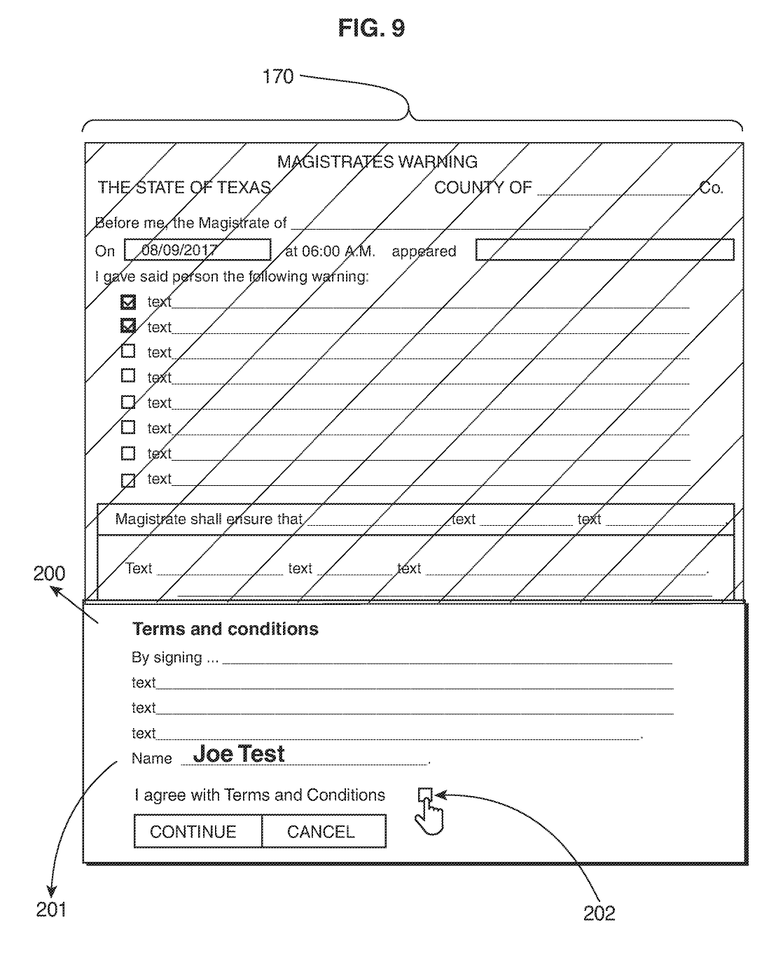

FIG. 9 is a screenshot illustrating an example use-case of the collaborative signature system and method. In this example, the document 170 remains grayed out and uneditable, the signature box 200 remains on display, and the name field 201 has been filled out with the name of a user (e.g., the first signer 101a, also known as Signer #1). Also visible is a checkbox 202 which, when checked, will take the user to a signature drawing box.

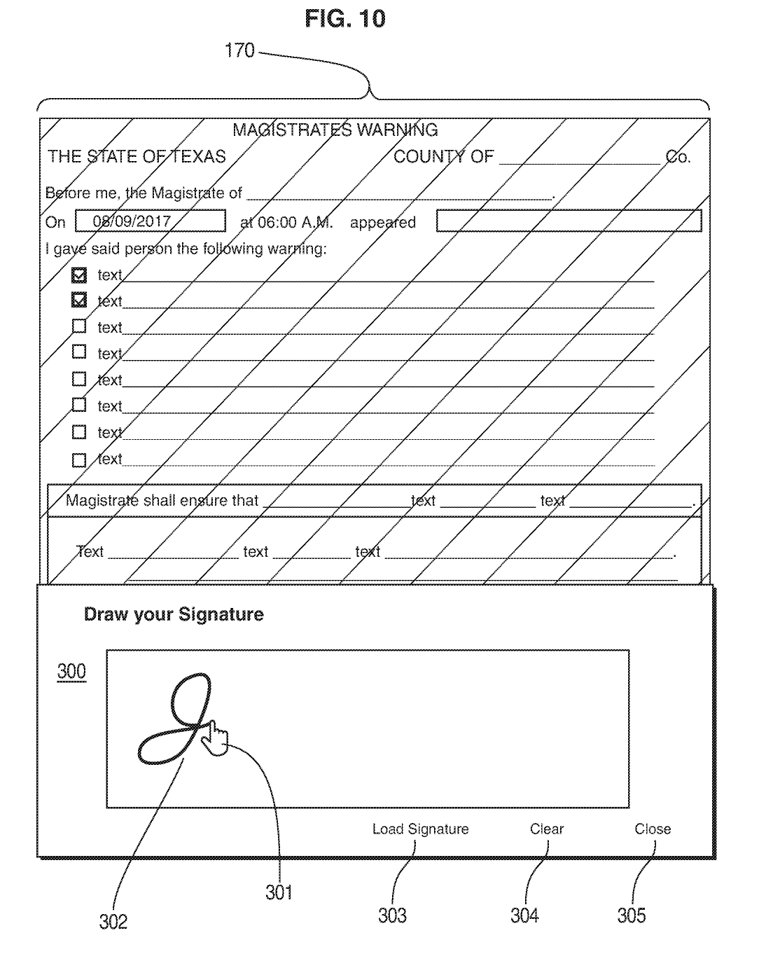

FIG. 10 is a screenshot illustrating an example use-case of the collaborative signature system and method. In this example, the document 170 remains grayed out and uneditable, and a signature drawing box 300 has been displayed, in which the user, with the aid of a mouse pointer 301, has begun to draw a signature 302. Also visible are three menu items 303, 304, and 305. The “Load Signature” option 303 indicates that the user has finished drawing the signature 302 and wishes to incorporate it into the document 170. The “Clear” option 304 indicates that the user is not satisfied with the signature 302 and wishes to start over. The “Close” option 305 indicates that the user no longer wishes to complete a signature 302, and wishes to close or exit from the signature drawing box 300. Other or additional menu choices may be included that further the goal of collecting the user's affirmative assent.

Signatures may be entered via touch screen, pre-scanned or uploaded image, signature pad, or mouse or trackpad input. In addition, tracking styluses exist which include accelerometers, magnetometers, optical scanners or other sensors to track the movement of the stylus over a surface, or by other methods known in the art. Such styluses may communicate wirelessly via Bluetooth or other wireless protocols, or may communicate via a wired connection such as USB, or by other methods known in the art. A tracking stylus may be employed to enter signatures for the collaborative signature system and method. In addition, a touch screen, signature pad, pre-scanned or uploaded image, mouse or trackpad input, or tracking stylus, along with character recognition or handwriting recognition, may be employed to enter text, dates, checkbox checks, and other inputs. A keyboard or voice control may also be employed to enter such data.

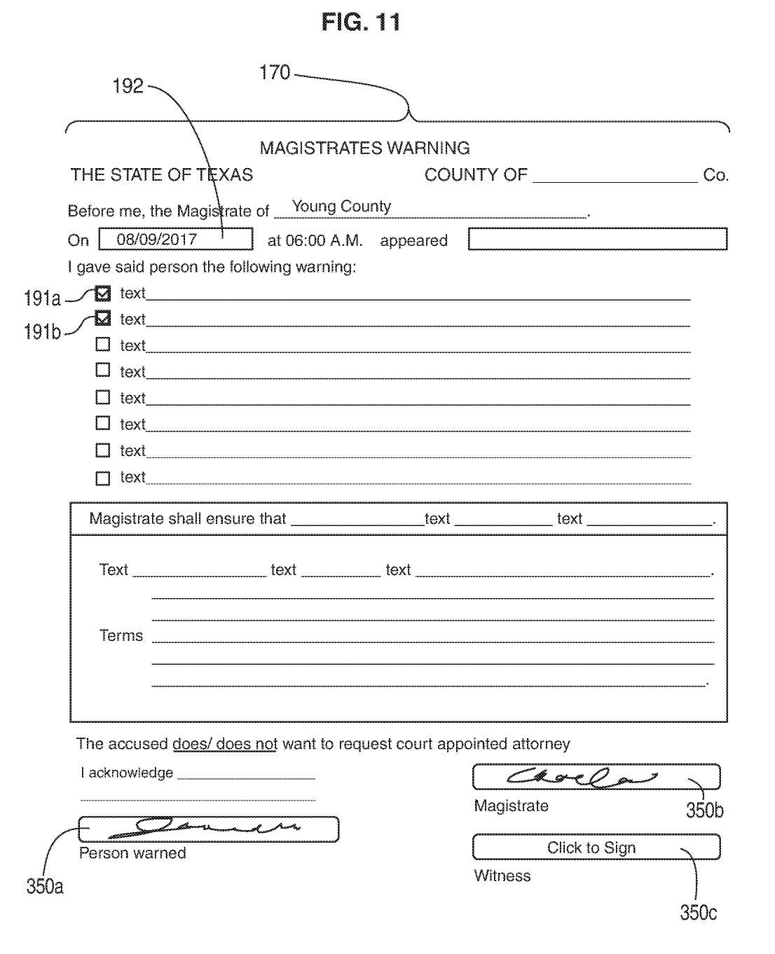

FIG. 11 is a screenshot illustrating an example use-case of the collaborative signature system and method. In this view, the filled-out text boxes 190a and 190b are not visible, but the filled-out date box 192 is visible, along with the checked checkboxes 191a and 191b. In addition, the signature 350a of a first user is visible in the document 170, along with the signature 350b of a second user. In the example, the signature 350c of a third user has not been entered, but the text “Click to Sign” (or similar text) indicates that by clicking on this box with the mouse pointer or similar method, the third user may be taken to a signature box 200 as depicted in FIG. 8.

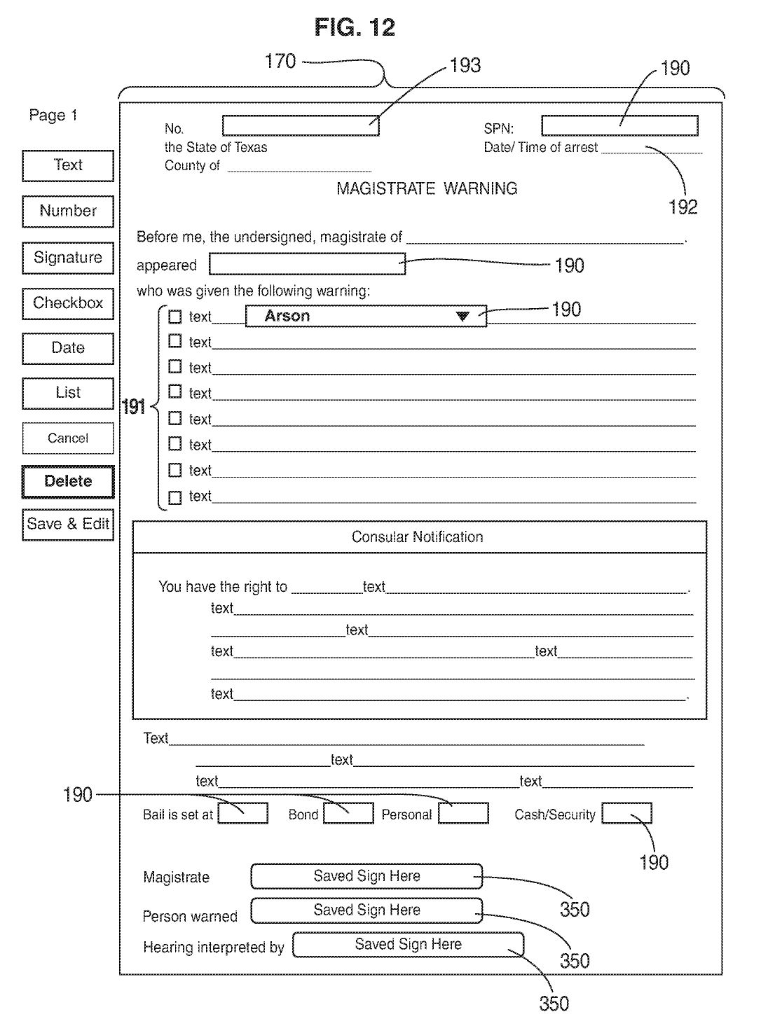

FIG. 12 shows an example template 160. Templates 160 are user uploaded multi-page forms that can be turned into an unlimited number of signable documents. Forms can be configured as collaborative documents through the entry of data into Text fields 190, Number fields 193, List fields 194, Date fields 192, Checkbox fields 191 and Signature fields 350. The main goal of the template 160 is to create a reusable form that can be loaded and reloaded between multiple sessions for ease of use. Once a template 160 has been edited in a session it is locked and can no longer be edited/deleted. The ability to Duplicate an existing template 160 allows for editing and updating a locked template 160.

Once filled out, the template 160 becomes a document 170 that may include text, fillable form fields (e.g., date field, name, etc.), and signature blocks (on the bottom) for Signee #1 and Signee #2, and possibly other signees as well. The document 170 to be signed is shown in more detail in FIGS. 5 and 6, and text has been filled in the form fields (e.g., indicated by the dot in Court # field in the top right). Check boxes have been selected in FIG. 7. It is noted that the changes to the document (e.g., text entries, check boxes, etc.) are displayed in real time to all logged in users. Logged in users may include Signee #1, Signee #2, and may also include other signees and/or other users. Other users need not be signees, and can be for example, representatives, witnesses, etc.

When the document 170 has been completed and is acceptable to both signees 101, a Signature box or Terms and Conditions box 200 is displayed, as shown in FIG. 8. The signee (e.g., one signee at a time) signs the Terms and Conditions to indicate assent to signing the document through the online signature system, as shown in FIG. 9. Once the Terms and Conditions have been accepted, the signee 101 (e.g., Signee #1) may sign the document 160 electronically (e.g., using a touchpad or other signature capture tool) as shown in FIG. 10.

The signatures 350 of all signees 101 are then displayed for all logged in users, e.g., as shown in FIG. 11. In an example, the e-signature is treated like any other field, the main difference being that it is entered using a graphical method such as an HTML5 Canvas via touch-screen, mouse, image or electronic signature pad, and consists of stored points, lines, curves, or vectors. Also, during the signature process the users will be presented with a Terms and Conditions Agreement consent box or signature box requiring a typed signature and a checkbox acknowledging the legal validity of the signature. In an example, this information is stored in the encrypted PDF (or other similar document display, storage, and encryption format) under the author field in the form of the user's typed name and the public IP Address for the physical location of each completed signature.

In an example, once everyone has signed, the session is closed. Closed sessions are completed/archived sessions that can be accessed at a later time for document and video retrieval.

It is noted that the examples shown and described are provided for purposes of illustration and are not intended to be limiting. For example, the system could be employed to authenticate documents written and signed by a single user, such as letters, official orders, and sworn statements, while providing the ability for other users to witness the process, and the ability for the system to archive video of the process. Still other examples are also contemplated.

1. A collaborative signature system, comprising:
at least one template stored in a database, the at least one template representing a document that is to be signed; and
a remote server executing program code to deliver the at least one template to at least a first signee and a second signee so that the signees can see the document to be signed substantially simultaneously, the remote server processing and displaying for the signees the signature of the first signee substantially simultaneously, and the remote server processing and displaying for all signees the signature of the second and all subsequent signees substantially simultaneously.

2. The collaborative signature system of claim 1, wherein the signees sign the document at substantially the same time, whether or not the signatures are directly observed by other signees.

3. The collaborative signature system of claim 1, wherein the signees sign the document at different times, whether or not the signatures are directly observed by other signees.

4. The collaborative signature system of claim 1, wherein the process of each signee entering his or her signature is recorded and stored in a video format.

5. The collaborative signature system of claim 1, further comprising the remote server processing and displaying for all signees substantially simultaneously other entries to the document to be signed.

6. The collaborative signature system of claim 5, wherein the other entries include at least one checkbox, text input, date, list, or number entered by at least one of the signees.

7. The collaborative signature system of claim 1, wherein the signatures of the signees are captured and displayed in real-time.

8. The collaborative signature system of claim 1, wherein the input of text, numbers, dates, lists, or checkbox checks is captured and displayed in real-time.

9. The collaborative signature system of claim 1, wherein the document to be signed is both viewable and editable by all logged in users regardless of status of the users as a signee until the document is signed.

10. The collaborative signature system of claim 1, wherein the signees are physically remote from one another.

11. The collaborative signature system of claim 1, wherein the signees are authenticated.

12. A collaborative signature method, comprising:
retrieving at least one template stored in a database, the at least one template representing a document that is to be signed;
delivering the at least one template to at least a first signee and a second signee so that both signees can see the document to be signed substantially simultaneously;
processing and displaying for both signees the signature of the first signee substantially simultaneously; and
processing and displaying for both signees the signature of the second signee substantially simultaneously.

13. The collaborative signature method of claim 12, further comprising processing and displaying for both signees substantially simultaneously changes to the document to be signed.

14. The collaborative signature method of claim 13, wherein the changes to the document include at least one checkbox, text input, date, list, or number entered by at least one of the signees.

15. The collaborative signature method of claim 12, further comprising a session started by a signee logging in, wherein the session is an instance of video and document sharing based around a single interchange between the signees, and wherein the session includes video recording and document sharing of preloaded templates in a collaborative environment with real-time editing according to a publisher/subscriber architecture.

16. The collaborative signature method of claim 12, wherein a client is subscribed to subsequent changes to the document in real-time, such that the client is notified every time a field in the document changes, wherein the fields include all available field types for a templates the document is based on.

17. The collaborative signature method of claim 12, wherein the document to be signed, and signatures of the signees are viewable and/or editable by all logged in users regardless of status as a signee.

18. The collaborative signature method of claim 12, further comprising merging changes input by one or more signee with the template and rendering a non-editable and encrypted electronically signed document including accepted changes to the document and at least one signature of the signees.

19. The collaborative signature method of claim 12, wherein the signees are physically remote from one another and the signees are authenticated.

20. A collaborative signature method, comprising:
starting a session when a user logs in, wherein sessions are instances of video and document sharing based around a single interchange between two or more individuals, wherein sessions enable video recording and document sharing of preloaded templates in a collaborative environment with real-time editing according to a publisher/subscriber architecture;
subscribing a client viewing a document to subsequent changes to the document in real-time, such that the client is notified every time a user changes a field in the document, the fields including all available field types for a templates the document is based on;
when all changes are complete, merging the changes with the template and rendering a non-editable and encrypted electronically signed document including accepted changes to the document and at least one signature.
